(19) United States
(12) Patent Application Publication
(10) Pub. No.: US 2012/0109968 A1
(43) Pub. Date: May 3, 2012

(54) INFORMATION PROCESSING APPARATUS, INFORMATION CREATING APPARATUS, INFORMATION PROCESSING METHOD, INFORMATION CREATING METHOD, INFORMATION PROCESSING POROGRAM, INFORMATION CREATINGN PROGRAM, AND RECORDING MEDIUM

(75) Inventors: Shinichiro Nonaka, Kanagawa (JP); Takashi Hashimoto, Tokyo (JP)

(73) Assignees: INCREMENT P CORPORATION, Kanagawa (JP); PIONEER CORPORATION, Kanagawa (JP)

(21) Appl. No.: 13/003,156

(22) PCT Filed: Jul. 7, 2008
(86) PCT No.: PCT/JP2008/062295

§ 371 Date: Mar. 2, 2011

(51) Int. Cl. G06F 17/30

(52) U.S. Cl. 707/741; 707/E17.049

(57) ABSTRACT

An information processing apparatus includes a point database of position information and address information (text data of an address without a predetermined area name) for a point and with which a point search process is executed; a map database that includes text data of an area name for map display and with which a map display process is executed; and a control unit that, when a process is executed that uses text data of an address of a search point retrieved by the point search process, acquires from the point database, the position information and address information of the search point, acquires based on the position information of the search point and from the map database, the text data of the area name in the address of the search point, combines the acquired address information and acquired text data, generating the text data of the address of the search point.

### TECHNICAL FIELD

The embodiments discussed herein are related to an information processing apparatus, an information creating apparatus, an information processing method, an information creating method, an information processing program, an information creating program, and a recording medium.

### BACKGROUND ART

Information processing apparatuses such as a navigation apparatus, a PND (personal navigation device), a mobile phone, and a PDA (personal digital assistant) having a function of displaying a map or searching for a point have been conventionally known.

Such types of information processing apparatuses include a point-of-interests (POI) database that stores text data such as address information of points used for point search, and a map database that stores map data having text data of an area name used for displaying a map (see for example Patent Document 1).

With reference to FIGS. 15 and 16, a conventional database is explained. FIG. 15 is a diagram illustrating a data structure of a conventional POI database. FIG. 16 is a diagram illustrating a data structure of a map database. In FIG. 15, a POI database 1500 stores POI data 1501 for each point. The POI data 1501 respectively store address information 1510 in addition to a POI classification code, POI latitude and longitude information and so on. Further, address information 1510 is made up of information such as house number information 1511, a street name 1512, a city name 1513.

A map database 1600 of FIG. 16 stores street link data 1610 as well as various data such as drawing data representing terrestrial objects. The street link data 1610 is made up of information such as various data such as data for calculating a route, a street name 1611, house number information 1612, and a city name 1613.

Patent Document 1: Japanese Laid-Open Patent Application Publication No. 2002-107153

### DISCLOSURE OF INVENTION

### Problem to be Solved by the Invention

However, according to the technique described in Patent Document 1, the text data of the address information such as the street name 1512 or the city name 1513 stored in the POI database 1500 possesses text data of name that is also possessed by the text data of the area name such as the street name 1611 or the city name 1613 stored in the map database 1600; whereby the size of data becomes large and impairs the performance of the information processing apparatus.

Especially when points have identical addresses exclusive of the house number, such at those facing the same street and having the street name included in the address, the text data for the street name is stored respectively in the POI database 1500 and the map database 1600, becoming a huge amount of data.

### Means for Solving Problem

In order to solve the above problems and achieve an object, an information processing apparatus as claimed in claim 1 includes: a point database that includes position information and address information of a point and with which a point search process is executed, the address information being text data of an address without a predetermined area name; a map database that includes text data of an area name for displaying a map and with which a map display process is executed; and a control unit that, when a process is executed that uses text data of an address of a search point retrieved by the point search process, acquires from the point database, the position information and the address information of the search point, acquires based on the position information of the search point and from the map database, the text data of the area name in the address of the search point, combines the address information of the search point and the text data of the area name, and generates the text data of the address of the search point.

An information creating apparatus as claimed in claim 7 includes: a map database that stores map data including text data of an area name for displaying a map; an acquiring unit that acquires from the map database map, map data including text data of an area name; an input unit that receives position information and address information of a point; a storage controlling unit that, based on the acquired map data, the received position information and the received address information and with respect to address information that includes a predetermined area name, stores the address information alone to a point database, excluding the predetermined area name.

An information processing method for an information processing apparatus that includes a point database having position information and address information of a point and a map database having text data of an area name for displaying a map, that executes a point search process using the point database, and that executes a map displaying process using the map database as claimed in claim 13, includes a first acquiring step of acquiring from the point database, when a process is executed that uses text data of an address of a search point retrieved by the point search process, position information and address information of the point; a second acquiring step of acquiring from the map database, text data of an area name in the address of the search point, based on the acquired position information of the search point; and a generating step of generating text data of the address of the search point by combining the address information of the search point and the text data of the area name.

An information creating method for an information creating apparatus that includes a map database storing map data having text data of an area name for display a map and a point database storing position information and address information of a point as claimed in claim 14, includes an acquiring step of acquiring from the map database, map data including text data of an area name; an input step of receiving position information and address information of a point; a storage control step of storing address information to the point database, wherein for address information that includes a predetermined area name, the address information alone is stored excluding the predetermined area name, based on the acquired map data, the received position information and the received address information.

An information processing program claimed in claim 15 causes a computer to execute the information processing method according to claim 13.

An information processing program claimed in claim 16 causes a computer to execute the information processing method according to claim 14.

A computer-readable recording medium as claimed in claim 17 stores the program according to claim 15 or 16.

### BRIEF DESCRIPTION OF DRAWINGS

FIG. 1 is a block diagram illustrating one example of a functional configuration of an information processing apparatus according to a first embodiment;

FIG. 2 is a flowchart illustrating one example of an information processing procedure performed by the information processing apparatus according to the first embodiment;

FIG. 3 is a block diagram illustrating one example of a functional configuration of an information creating apparatus according to a second embodiment;

FIG. 4 is a flowchart illustrating one example of an information creating procedure of the information creating apparatus according to the second embodiment;

FIG. 5 is a block diagram illustrating one example of a hardware configuration of a navigation apparatus according to Example 1;

FIG. 6 is a diagram illustrating a data structure of a POI database according to Example 1;

FIG. 7 is a diagram illustrating an outline of recorded data of a point according to Example 1;

FIG. 8 is a flowchart illustrating an information processing process performed by the navigation apparatus according to Example 1;

FIG. 9 is a block diagram illustrating one example of a hardware configuration of an information creating server according to Example 2.

FIG. 10-1 is a flowchart illustrating one example of an information creating process conducted by an information creating server according to Example 2;

FIG. 10-2 is a flowchart illustrating one example of an information creating process conducted by an information creating server according to Example 2;

FIG. 11 is a diagram illustrating a relation between a link of format A and a point;

FIG. 12 is a diagram illustrating a relation between a link of format B and a point;

FIG. 13 is a diagram illustrating a relation between a link of format B and a point;

FIG. 14 is a diagram illustrating a relation between a point and a link expressed with the format A even when there are multiple links;

FIG. 15 is a diagram illustrating a data structure of a conventional POI database;

FIG. 16 is a diagram illustrating a data structure of a map database.

### EXPLANATIONS OF LETTERS OR NUMERALS

100 Information processing apparatus
110 Point database
120 Map database
130 Input unit
140 Searching unit
150 Display control unit
160 Output unit
170 Control unit
171 First acquiring unit
172 Second acquiring unit
173 Generating unit
300 Information creating apparatus
310 Point database
320 Map database
330 Input unit
340 Acquiring unit
350 Storage controlling unit
500 Navigation apparatus
900 Information creating server

### BEST MODE(S) FOR CARRYING OUT THE INVENTION

Preferred embodiments of an information processing apparatus, an information creating apparatus, an information processing method, an information creating method, an information processing program, an information creating program, and a recording medium according to the present invention will be explained with reference to the accompanying drawings.

### First Embodiment

### (Functional Configuration of Information Processing Apparatus)

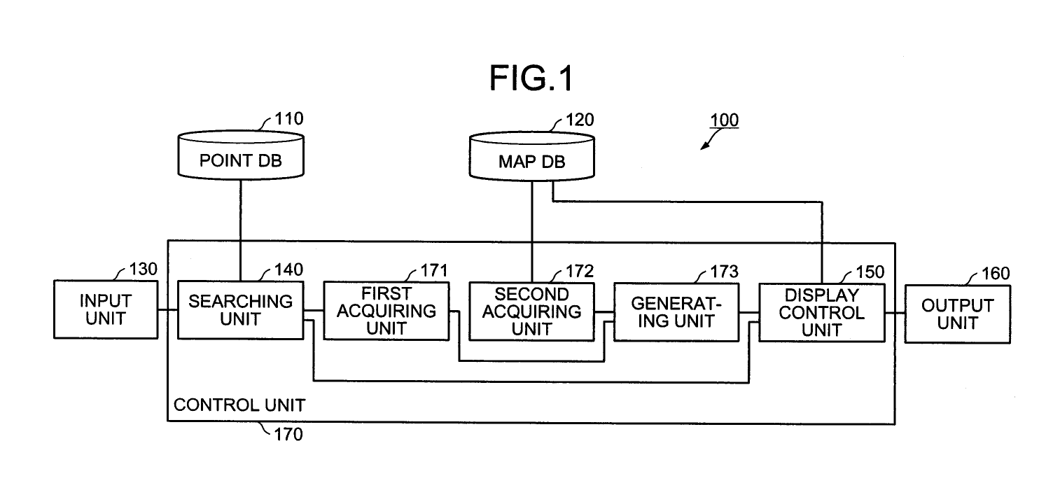

With reference to FIG. 1, a functional configuration of an information processing apparatus according to a first embodiment of the present invention is explained. The information processing apparatus can execute point search processing utilizing a point database and map display processing utilizing a map database. The information processing apparatus is implemented, for example, by an electronic device such as a navigation apparatus, a PND, a mobile phone and a PDA.

FIG. 1 is a block diagram illustrating one example of a functional configuration of the information processing apparatus according to the first embodiment. In FIG. 1, an information processing apparatus 100 includes a point database (point DB) 110, a map database (map DB) 120, an input unit 130, a searching unit 140, a display control unit 150, an output unit 160, and a control unit 170. The searching unit 140 and the display control unit 150 are included in the control unit 170.

The point DB 110 corresponds to a POI database and stores information including position information and address information on each point. The position information indicates information on latitude and longitude or information on an area. The address information is text data indicating an address of each point. An address having a given area name is stored without the given area name. The given area name is a geographical name or a name of a terrestrial feature and specifically a street name or a city name.

The input unit 130 receives a keyword to be used for a search. The searching unit 140 utilizes the keyword input into the input unit 130 and searches in the point DB 110 for an appropriate point. An example of a search method of the searching unit 140 is an area search but may include a genre search or a name search.

Additional explanation of these methods is given here. The area search is a method of searching for a point in an area specified by a user. The genre search is a method of searching with a genre specified by the user for a point or a genre in a lower level corresponding to the genre. The name search is a method of searching with a facilities name etc. specified by the user for a point corresponding to the name.

The map DB 120 stores map data including text data of an area name for displaying a map. The text data of an area name is, for example, a municipality name, a facilities name, a street name displayed on a map. The display control unit 150 reads out the map data including the text data from the map DB 120 and controls the output unit 160 such as a displaying unit to output the map data.

The control unit 170 includes a first acquiring unit 171, a second acquiring unit 172, and a generating unit 173. When the first acquiring unit 171 conducts processing of using the text data of an address belonging to a point (hereinafter “search point”) retrieved at the point search processing, the first acquiring unit 171 acquires from the point DB 110, the position information and the address information on the search point. The processing of using the text data of an address includes, other than processing necessitated by the point search processing, processing necessitated by an audio navigation process where a text-to-speech synthesis is performed and output.

The second acquiring unit 172, based on the position information of the search point, acquires the text data of an area name of the address of the search point from the map DB 120. Specifically, when the address of the search point stored in the point DB 110 lacks a specific name such as a street name or a city name, the second acquiring unit 172 acquires text data of the specific name from the map DB 120, using the latitude and longitude as the position information of the search point.

The generating unit 173 combines the address information of the search point acquired by the first acquiring unit 171 from the point DB 110 and the text data of area name acquired by the second acquiring unit 172 from the map DB 120, and generates text data of the address of the search point. Specifically, the generating unit 173 supplements the address information lacking the specific name such as a street name or a city name with the area name acquired by the second acquiring unit 172 from the map DB 120 and generates the text data of the address of the search point. The generated text data is output from the output unit 160 under the control of the display control unit 150.

Further, as described above, a typical example of an area name is a street name. In this case, the second acquiring unit 172 acquires from the map DB 120, text data of street name belonging to a street near the search point as text data of the street name in the address of the search point. The generating unit 173 combines the address information of the search point acquired by the first acquiring unit 171 from the point DB 110 and the text data of street name acquired by the second acquiring unit 172 from the map DB 120 to generate the text data of the address of the search point.

In this embodiment, for a point having multiple streets nearby, the point DB 110 may store specifying information used for specifying a street having a street name that is included in an address of the point. The specifying information is information by which a street can be specified and that has smaller data size compared with the text data of street name. For example, the specifying information is text data of a minimal character string such as the initial letter of the street name.

In this configuration including the point DB 110 storing such specifying information, if there are multiple streets near the search point, the second acquiring unit 172 acquires from the map database, text data of a street name of a street specified by the specifying information for the search point, as text data of a street name in the address of the search point. The generating unit 173 combines the address information of the search point acquired from the point DB 110 and the text data of street name acquired by the second acquiring unit 172 from the map DB 120, and generates text data for the address of the search point.

Further, in this embodiment, for a point whose nearby street has multiple street names, the point DB 110 may store priority information indicating an order of priority for the multiple street names. To have multiple street names means that a street has both an official name and alternate names. The priority information is information used to designate one of the multiple street names for displaying an address.

When a street near the search point has multiple street names, the second acquiring unit 172 acquires from the map DB 120, text data of a street name having priority according to the priority information on the multiple street names, as text data of the street name in the address of the search point. In this case, the generating unit 173 combines the address information of the search point acquired from the point DB 110 and the text data of the street names acquired by the second acquiring unit 172 from the map DB 120, and generates text data of the address of the search point.

Furthermore, as described above, a typical example of an area name is a city name. In this case, the second acquiring unit 172 acquires from the map DB 120, text data of the city name of the city to which the search point belongs, as text data of the city name in the address of the search point. The generating unit 173 combines the address information of the search point acquired by the first acquiring unit 171 from the point DB 110 and the text data of the city name acquired by the second acquiring unit 172 from the map DB 120, and generates text data of the address of the search point.

Furthermore, in this embodiment, for a point with respect to which an area name included in an address cannot be acquired from the map DB 120, the point DB 110 may store text data of an address including the area name as address information of the point. Specifically, for points whose address does not include an area name such as a street name or a city name or points that do not have streets nearby, the point DB 110 stores text data of an address including an area name.

### (Procedure of Information Processing at Information Processing Apparatus)

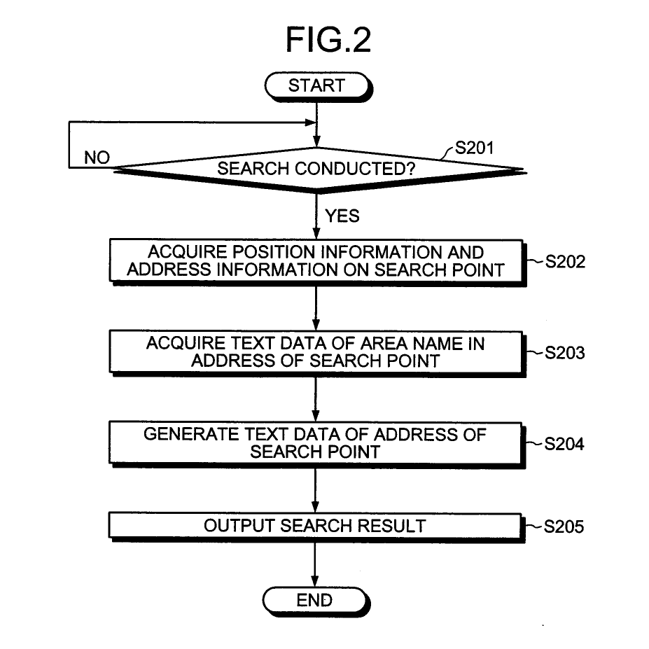

With reference to FIG. 2, an information processing procedure of the information processing apparatus 100 is explained. FIG. 2 is a flowchart illustrating one example of the information processing procedure performed by the information processing apparatus 100 according to the first embodiment.

According to the flowchart of FIG. 2, the information processing apparatus 100 determines whether the searching unit 140 has performed search processing (step S201). Until the search processing is performed, the procedure remains in standby (step S201: NO-loop). Once the search processing is performed (step S201: YES), the first acquiring unit 171 acquires from the point DB 110, position information and address information of a search point (step S202).

Based on the position information of the search point, the second acquiring unit 172 acquires from the map DB 120, text data of area name for an address of the search point (step S203). The generating unit 173 combines the address information of the search point acquired by the first acquiring unit 171 from the point DB 110 and the text data of the area name acquired by the second acquiring unit 172 from the map DB 120, and generates text data of the address of the search point (step S204). The generated text is output from the outputting unit 160, as a search result, under the control of the display control unit 150 (step S205), ending the procedure.

As explained above, according to the information processing apparatus 100 of the first embodiment, text data of an address lacking a given area name stored in the point DB 110 is complemented by text data of the given area name so that text data of the address is generated. As a result, the amount of data in the point DB 110 can be reduced. Consequently, storage of the information processing apparatus 100 is efficiently used and the deterioration of performance of the information processing apparatus 100 is prevented.

When the area name above is replaced with a street name, text data of an address lacking a street name stored in the point DB 110 may be complemented by text data of the street name stored in the map DB 120. As a result, for geographical points having an identical address except for the house number, such as points facing the same street whose name is included in the address, the volume of data amounting to street names can be reduced in the point DB 110.

Further, for a point having multiple streets nearby, specifying information stored in the point DB 110 may be complemented by the text data of a street name of a street specified by the specifying information stored in the map DB 120. As a result, the volume of data in the point DB 110 can be reduced by the difference between the text data and the specifying information.

Furthermore, for a point whose nearby street has multiple street names, priority information stored by the point DB 110 may be complemented by text data, stored in the map DB 120, of a street name of a street having priority according to the priority information. As a result, the volume of data in the point DB 110 can be reduced and an appropriate address can be displayed even for a point associated with multiple street names. Especially, because in North America, 30% of locations have multiple street names, the reduction of the volume of data in the point DB 110 becomes effective for such a region.

When the area name above is a city name, text data lacking a city name stored in the point DB 110 may be complemented by the text data of the city name stored in the map DB 120. As a result, for points having the same city name, the volume of data amounting to city names can be reduced in the point DB 110.

For a point with respect to which an area name included in an address cannot be acquired from the map DB 120, text data of an address including the area name may be stored in the point DB 110, as address information of the point. As a result, for a point whose address does not include the area name or a point having no street nearby, a proper address display can be performed in a conventional manner.

### Second Embodiment

### (Functional Configuration of Information Creating Apparatus)

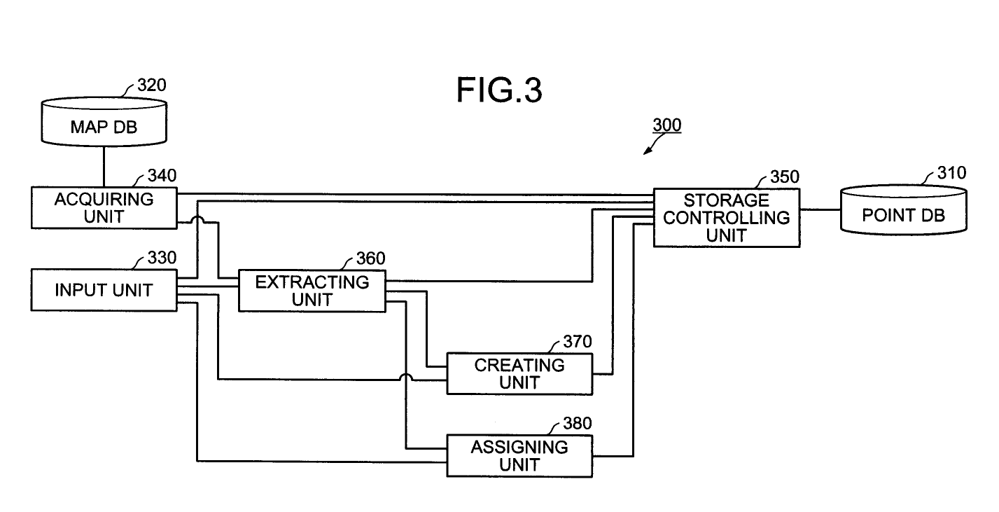

With reference to FIG. 3, a functional configuration of an information creating apparatus according to a second embodiment of the present invention is explained. An information creating apparatus of the second embodiment creates the point DB 110 used by the information processing apparatus 100 of the first embodiment. The information creating apparatus includes a map database (map DB) that stores map data including text data of an area name for displaying a map, and stores data in a point database (point DB) that stores position information and address information of each point. The information creating apparatus may be implemented by a computer apparatus such as a server and a PC (Personal Computer).

FIG. 3 is a block diagram illustrating one example of a functional configuration of the information creating apparatus according to the second embodiment. In FIG. 3, an information creating apparatus 300 includes a point DB 310, a map DB 320, an input unit 330, an acquiring unit 340, a storage controlling unit 350, an extracting unit 360, a creating unit 370, and an assigning unit 380.

The acquiring unit 340 acquires from the map DB 320, map data including text data of an area name. The area name indicates a geographical name or a name of a terrestrial feature, for example, a street name or a city name. To the input unit 330, position information and address information of each point is input. The input may be input through an operation by the user or read-out from the point DB.

Based on the map data acquired by the acquiring unit 340, and the position information and the address information input to the input unit 330, the storage controlling unit 350 stores the address information in the point DB 310, deleting the given area name when the address information includes a given area name. Specifically, the storage controlling unit 350 specifies a region including each point or a neighbor of each point based on the position information of each point and the position information of features included in the map data. If the storage controlling unit 350 determines from the text data of the specified area name and the address information that address information of a point includes text data of an area name, the storage controlling unit 350 deletes the area name and stores the address information to the point DB 310.

Furthermore, as described above, a typical example of the area name is a street name. In this case, the extracting unit 360 extracts streets near each point, based on the map data acquired by the acquiring unit 340 and the position information and the address information input into the input unit 330. The storage controlling unit 350 stores the address information to the point DB 310, excluding the street name if the street name of the street extracted by the extracting unit 360 is included in the address information.

Furthermore, in this embodiment, if the extracting unit 360 extracts multiple streets near a point, the creating unit 370 creates specifying information for specifying a street name included in an address at the point based on the address information input into the input unit 330. The specifying information is, for example, text data of a minimal character string such as the initial letter of the street name as explained in the first embodiment. Specifically, the creating unit 370 determines whether there are multiple streets near the point, based on the position information of a street included in the map data and the position information of each point. If it is determined that there are multiple streets, the creating unit 370 creates specifying information for a point whose address information includes a street name using the text data and the address information of the multiple streets.

In this case, the storage controlling unit 350 stores the specifying information created by the creating unit 370 to the point DB 310, excluding street names. In other words, the storage controlling unit 350 does not store a street name among the address information but rather stores to the point DB 310, the specifying information corresponding to the street name.

Furthermore, in this embodiment, when a street extracted by the extracting unit 360 and near a point has multiple street names, the assigning unit 380 assigns, based on the address information input into the input unit 330, priority information that indicates an order of priority of street names included in an address of the point. Multiple street names are an official name and an alternate name. The priority information is, as the priority information explained in the first embodiment, information used to designate one of the multiple street names for displaying an address.

In this case, the storage controlling unit 350 stores address information to the point DB 310, excluding the street name, after the assigning unit 308 assigns the priority information. In other words, the storage controlling unit 350 does not store a street name among the address information to the point DB 310 but rather stores the priority information for designating the street name.

As described above, a typical example of the area name is a city name. In this case, the extracting unit 360 extracts a city name near each point, based on the map data acquired by the acquiring unit 340 and the position information and the address information input into the input unit 330. If the city name extracted by the extracting unit 360 is included in the address information, the storage controlling unit 350 stores the address information to the point DB 310, excluding the city name.

In this embodiment, for address information of a point whose address information does not include a given area name, the storage controlling unit 350 stores to the point DB 310, address information input into the input unit 330. Specifically, for points whose address information does not include a predetermined area name such as a street name or a city name or points that do not have street nearby, the storage controlling unit 350 stores to the point DB 310, text data of an address including the area name.

### (Information Processing Procedure of Information Creating Apparatus)

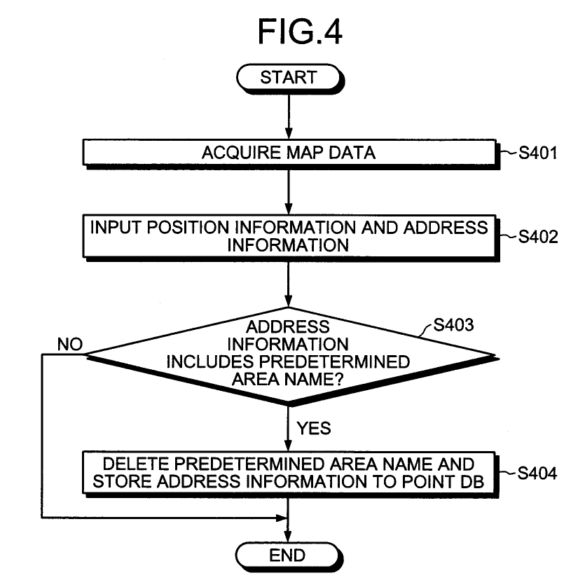

With reference to FIG. 4, an information creating procedure of an information creating apparatus 300 according to the second embodiment is explained. FIG. 4 is a flowchart illustrating one example of the information creating procedure of the information creating apparatus 300 according to the second embodiment.

In the flowchart of FIG. 4, the information creating apparatus 300 acquires map data including text data of area name, from the map DB 320 via the acquiring unit 340 (step S401) and inputs position information and address information of each point via the input unit 330 (step S402). Based on the acquired map data and the input position information and the address information, the information creating apparatus 300 determines whether the address information includes a predetermined area name (step S403).

If it is determined that the address information includes the area name (step S403: YES), the address information, excluding the area name, is stored to the point DB 310 (step S404), ending the procedure. If it is determined that the address information does not include the area name (step S403: NO), the procedure ends.

As explained above, according to the information creating apparatus 300 according to the second embodiment, if the address information of the points includes a predetermined area name that has been stored in the map DB 320, the point DB 310 does not store the area name, thereby reducing the volume of data in the point DB 310.

If the area name is a street name and the address information of a point includes a street name that has been stored in the map DB 320, the volume of data amounting to the street name can be reduced in the point DB 310 by deleting the street name from the address information.

If there are multiple streets near a point, creating specifying information for specifying a street name and storing to the point DB 310, the specifying information with the street name excluded from the address information reduces the volume of data in the point DB 310 by the amount of the difference between the text data and the specifying information.

Furthermore, if a street near a point has multiple street names, assigning priority information indicative of an order of priority of street names and storing to the point DB 310, address information with the priority information excluding the street names can reduce the volume of data in the point DB 310 and provides proper address display even for a point having multiple street names.

If the area name is a city name and the address information of each point includes a city name stored in the map DB 320, by storing the address information without the city name, the volume of data amounting to the city name can be reduced in the point DB 310.

Furthermore, for a point whose address information does not include a predetermined area name, by storing the address information including the predetermined area name in the point DB 310, a proper address can be displayed in a conventional manner for a point whose address does not include the predetermined area name or a point that has no street nearby.

### Example 1

Example 1 of the present invention is explained below. In Example 1, one example of an information processing apparatus implemented by a navigation apparatus is explained. In Example 2 which will be described later, one example of an information creating apparatus implemented by an information creating server is explained.

### (Hardware Configuration of Navigation Apparatus)

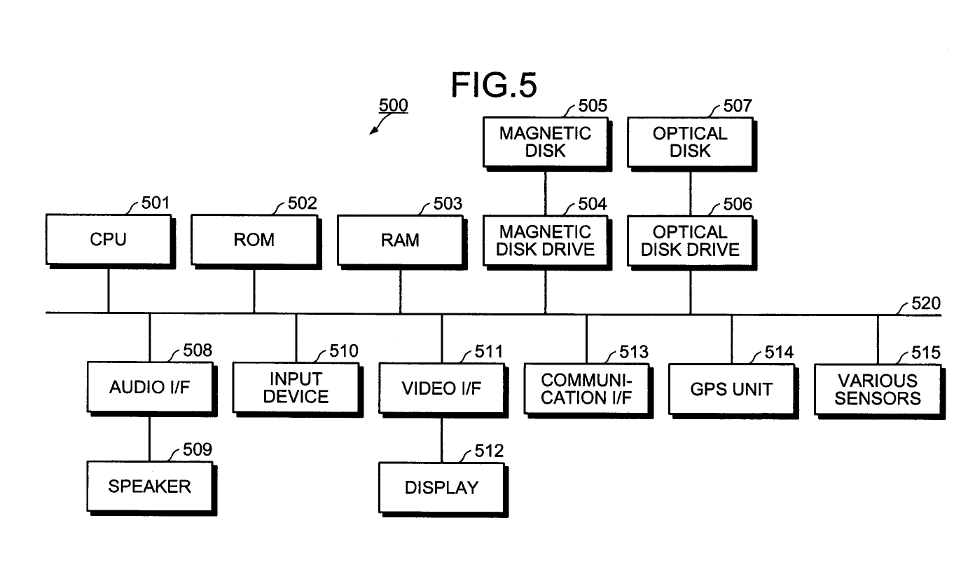

With reference to FIG. 5, a hardware configuration of a navigation apparatus according to Example 1 is explained. FIG. 5 is a block diagram illustrating one example of a hardware configuration of the navigation apparatus according to Example 1.

In FIG. 5, a navigation apparatus 500 includes a CPU 501, a ROM 502, a RAM 503, a magnetic disk drive 504, a magnetic disk 505, an optical disk drive 506, an optical disk 507, an audio I/F (interface) 508, a speaker 509, an input device 510, a video I/F 511, a display 512, a communication I/F 513, a GPS unit 514, and various sensors 515, respectively connected by a bus 520.

The CPU 501 governs overall control of the navigation apparatus 500. The ROM 502 stores therein various programs such as a boot program, a map displaying program, a facilities search program, and an information processing program. The RAM 503 is used as a work area of the CPU 501 and stores a common name dictionary.

The map displaying program is stored in the magnetic disk 505 which is described later. The map displaying program is a program that displays, for example, a map around a current position using street map data made up of data for drawing and name data (text data) that is stored in the magnetic disk 505 which is described later. The facilities search program is a program that searches a point corresponding to a keyword input by a user with, for example, POI address information stored in the magnetic disk 505.

The information processing program acquires, for text data of an address of a point (hereinafter “search point”) retrieved by executing the facilities search program, position information and address information of the search point from the magnetic disk 505. The information processing program also acquires text data of a street (link) name at the address of the search point from the magnetic disk 505, based on the position information of the search point, and generates text data of the address of the search point by combining the address information and the text data of the street name at the search point.

If there are multiple streets near the search point, the information processing program, using specifying information for specifying a street, acquires text data of a street name from the magnetic disk 505 and generates text data of an address of the search point.

Further, if a street near the search point has multiple street names, the information processing program, using priority information (a recorded order) indicating an order of priority of the street names, acquires text data of street names from the magnetic disk 505 and generates text data of an address of the search point.

The control unit 170 in FIG. 1 introduced in the first embodiment is implemented by the CPU 501. In other words, the CPU 501 executes the map displaying program, implementing the function of the display control unit 150, executes the facilities search program, implementing the function of the searching unit 140, and executes the information processing program, implementing the functions of the first acquiring unit 171, the second acquiring unit 172, and the generating unit 173.

The magnetic disk drive 504 controls the reading/writing of data to/from the magnetic disk 505 under the control of the CPU 501. The magnetic disk 505 stores data written under the control of the magnetic disk drive 504. The magnetic disk 505 is, for example, a HD (hard disk drive) or a FD (flexible disk).

The magnetic disk 505 includes point database (POI database) that stores point data including position information and address information of each point, and map database that stores street map data including text data of street names for displaying map. For a point whose address information includes a predetermined street name, the address information of the point data is stored without the street name. For a point whose address information does not include a predetermined street name, the magnetic disk 505 stores text data of an address in a conventional manner.

In the case of a portable navigation device (PND), the data stored in the magnetic disk 505 is stored, for example, in a flash memory. The point DB 110 and the map DB 120 in FIG. 1 as described in the first embodiment are implemented by the magnetic disk 505.

The optical disk drive 506 controls the reading/writing of data from/to the optical disk 507 under the control of the CPU 501. The optical disk 507 is a removable recording medium from which data is read under the control of the optical disk drive 506. The optical disk 507 may be a writable recording medium. The removable recording medium may be a medium other than the optical disk 307, such as an MO and a memory card.

The audio I/F 508 is connected to the speaker 509 for audio output. The speaker 509 outputs sounds. The input device 510 includes a remote controller, a keyboard, a mouse, a touch panel and so on that includes keys for entering characters, numeric values, and various instructions. The input device 510 may be implemented by one of, or two or more of the remote controller, the keyboard, the mouse, and the touch panel. Via the input device 510, a user enters keywords for a search. The input unit 130 in FIG. 1 described in the first embodiment is implemented by the input device 510.

The video I/F 511 is connected to the display 512. The video I/F 511 is made up of, for example, a graphic controller that controls the display 512, a buffer memory such as a VRAM (video RAM) that temporarily stores immediately displayable image information, and a control IC that controls the display 512, based on image data output from the graphic controller. The output unit 160 described in the first embodiment is implemented by the display 512 or the speaker 509.

The communication I/F 513 is connected to a network wirelessly functioning as an interface between the navigation apparatus 500 and the CPU 501.

The GPS unit 514 receives signals from GPS satellites and outputs information indicating the current position of a vehicle. Information from the GPS unit 514 is used to calculate the current position of the vehicle by the CPU 501 using values output from the various sensors 515 described hereinafter. Information indicating the current position is information such as latitude, longitude, and altitude that specifies one point on a map.

The various sensors 515 may be a vehicle velocity sensor, an acceleration sensor, or an angular velocity sensor and output information used to judge the position or the behavior of the vehicle. Output from the various sensors 515 is used by the CPU to calculate the current position, or a variation of speed or orientation of the vehicle.

The point DB 110, the map DB 120, the input unit 130, the searching unit 140, the display control unit 150, the output unit 160, and the control unit 170 of the information processing apparatus 100 depicted in FIG. 1 are implemented by the CPU 501 executing a given program using programs and data stored in the ROM 502, the RAM 503, the magnetic disk 505, and the optical disk 507 of the navigation apparatus 500 depicted in FIG. 5 to control each components of the navigation apparatus 500.

In other words, with the CPU 501 executing an information processing program stored in the ROM 502, a recording medium, the navigation apparatus 500 according to the present example implements functions of the information processing apparatus 100 depicted in FIG. 1 according to the information processing procedure depicted in FIG. 2.

### (Point Data According to Example 1)

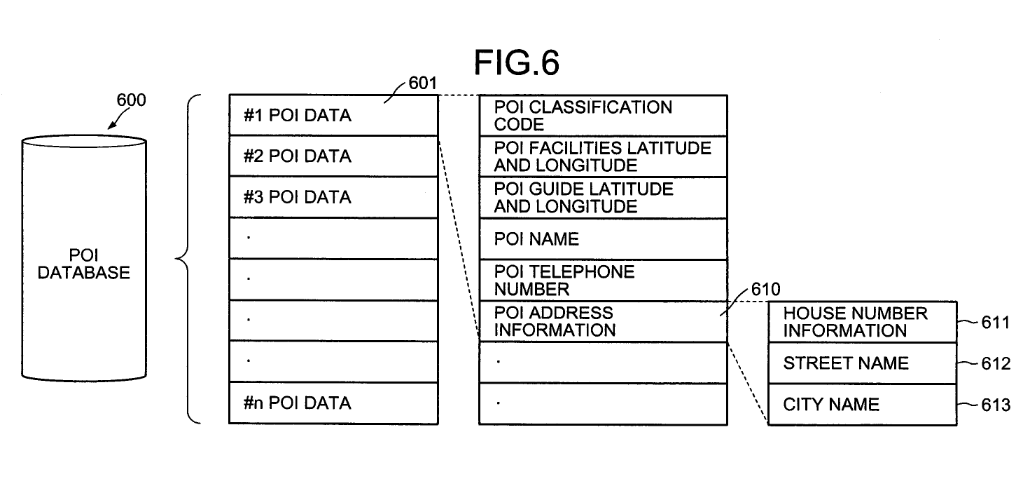

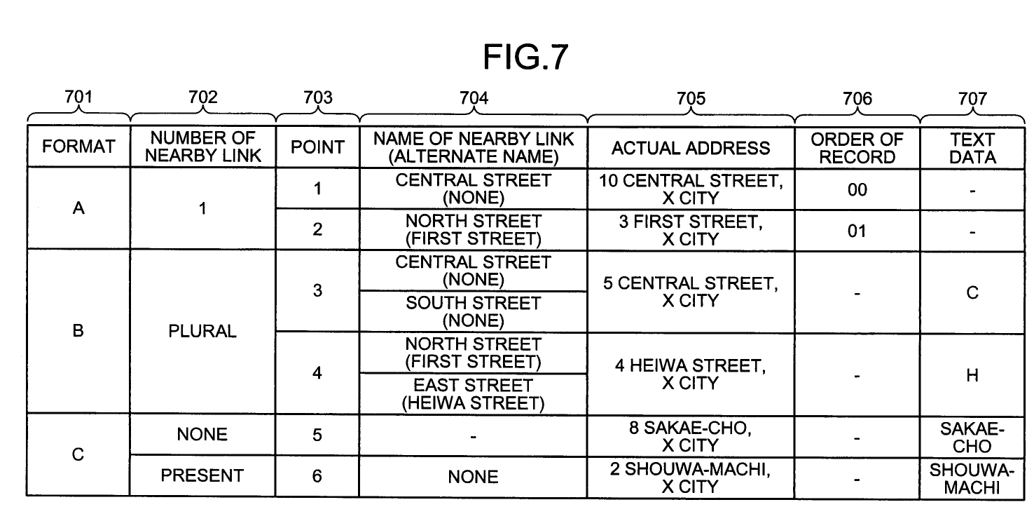

With reference to FIG. 6 and FIG. 7, an outline of point data according to Example 1 is explained. FIG. 6 is an explanatory diagram illustrating a data structure of a POI database according to the present Example. FIG. 7 is an explanatory diagram illustrating an outline of recorded data of each point according to the present example.

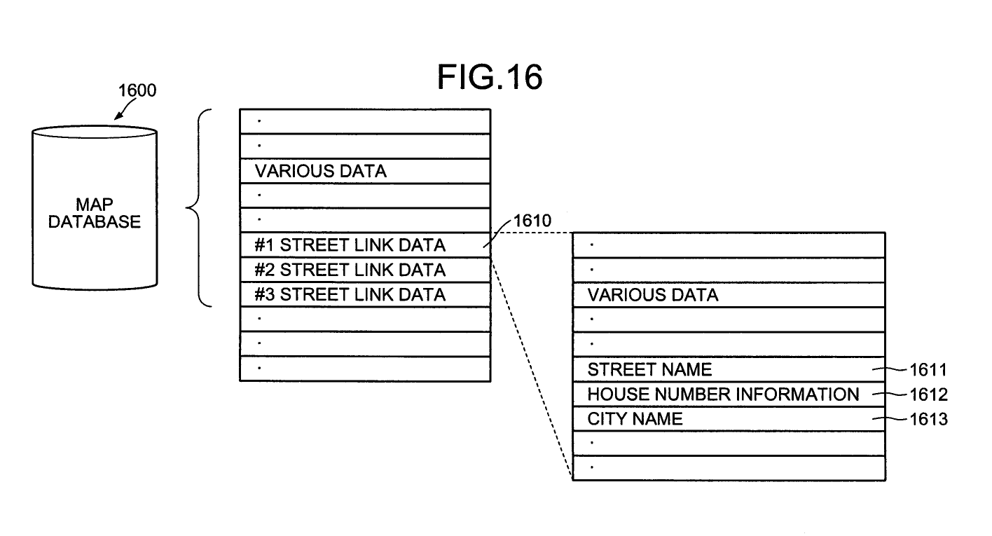

In FIG. 6, the POI database 600 stores POI data 600 of each point. The POI data 601 each includes a POI classification code, POI latitude and longitude information, and so on as well as address information 610. Further, the address information 610 is made up of information such as house number information 611 and a city name 613, lacking a street name 612 which was stored before. Details will be explained with reference to FIG. 7. Here, the street name 612 is not omitted from all POI data 601 but rather is omitted from predetermined street names. In this example, the map database is identical to that of FIG. 16.

In the present example, the area name that is not stored in the POI database 600 is the street name 612 but the city name 613 may be omitted. Namely, even if the city name 613 is not stored in the POI database 600, the text data corresponding to the city name 613 can be obtained from the map database and used instead.

In FIG. 7, reference numeral 701 indicates a record format of the POI data. “A” of format 701 denotes that the number of nearby links 702 is one and the address includes a name(s) of the link. A nearby link name 704 is stored in the map database. The term “nearby” indicates, for example, a range of 15 m from a point such as a facility.

In the format A where reference numeral 703 indicates a point, a point 1 has a link nearby named “central street” and includes a name of “central street” in an actual address 705. In this case, the POI database does not store text data 707 corresponding to “central street” but rather stores text data with “central street” omitted. A recorded order 706 will be explained later.

In the format A, a point 2 has a link nearby named “north street”. “North street” has another name of “first street”. The official name and the alternate name are stored in the map database. The recorded order 706 as the priority information is set to “01” in the actual address 705 of the point 2. The recorded order 706 indicates an order of record in a street database and usually an official name comes first and the alternate name comes next.

In the present example, if the address information matches the official name that is recorded first in the map database, the recorded order is set to “00”. If the address information matches the alternate name that is recorded in the next place in the map database, the recorded order is set to “01”. As the actual address 705 of the point 2 includes the alternate name of “first street”, the recorded order 706 is set to “01”.

There may be multiple official names or alternate names. In this case, the map database stores text data of a corresponding number of names. The recorded order 706 for designating text data of names is set in the POI database. In this example, for the recorded order 706, the recorded order at the street database minus one is set. Namely, the first in the street database is set to “00”, the second to “01”, and the third to “02”. However, embodiments are not limited to this example and without the recorded order “00”, the recorded order “01” . . . “03” may be given instead.

“B” of the format 701 indicates that a nearby link number 702 is plural and a name of address includes a name of the link. The nearby link name 704 is stored in the map database. In the format B, a point 3 has a link nearby named “central street” and a link named “south street”, and the actual address 705 includes a name “central street”. In this case, the POI database includes the minimal character string of text data 707, “c” as specifying information for uniquely specifying “central street” by forward searching. If the actual address 705 of the point 3 includes “south street”, the POI database stores the specifying information “s” as the text data 707 representing “south street”.

A point 4 of format B has nearby a link named “north street” and a link named “east street”. “North street” has another name “first street”. “East street” has another name “heiwa street”. The official name and the alternate name are stored in the map database. The actual address of the point 4 includes the name of “heiwa street” and in this case, the POI database stores the specifying information “h” as the text data 707 of the minimal character string that indicates “heiwa street”.

“C” of the format 701 indicates a recorded format where there is no nearby link, a nearby link does not include a name even if there is a nearby link, or the actual address 705 does not include a name of a nearby link. In the format C, the point 5 does not have a nearby link. In this case, the POI database stores text data of “sakae-cho” corresponding to an area name, without deletion of the predetermined area name.

In the format C, the point 6 has a nearby link that does not have a name, or the actual address 705 does not include a name of the nearby link. In this case, the POI database stores text data of “shouwa-machi” corresponding to an area name, without deletion of the predetermined area name.

The data structure of address information is further explained here. The address information is made up of a header part and a data part. The header part is expressed with one byte where a number for specifying the recorded format A-C is recorded in the upper three bits. Specifically, the number is “0” for the format A, “1” for the format B, and “2” for the format C. In the case of the format A, the header part is given a recorded order using the lower five bits. Accordingly, the format A does not have the data part.

Further, in the case of the format B, a record byte of a text for comparing names using the specifying information is set to the header part in the lower five bits. The data part of the format B records the specifying information for comparing names by the forward matching. The data part of the format B records text data up to the maximum of 31 characters. In the case of the format C, a record byte of a text is set in the lower five bits. The data part of the format C stores the entire address information. The data part of the format C records text data up to the maximum of 31 characters.

### (Outline of Information Processing Process Performed by Navigation Apparatus)

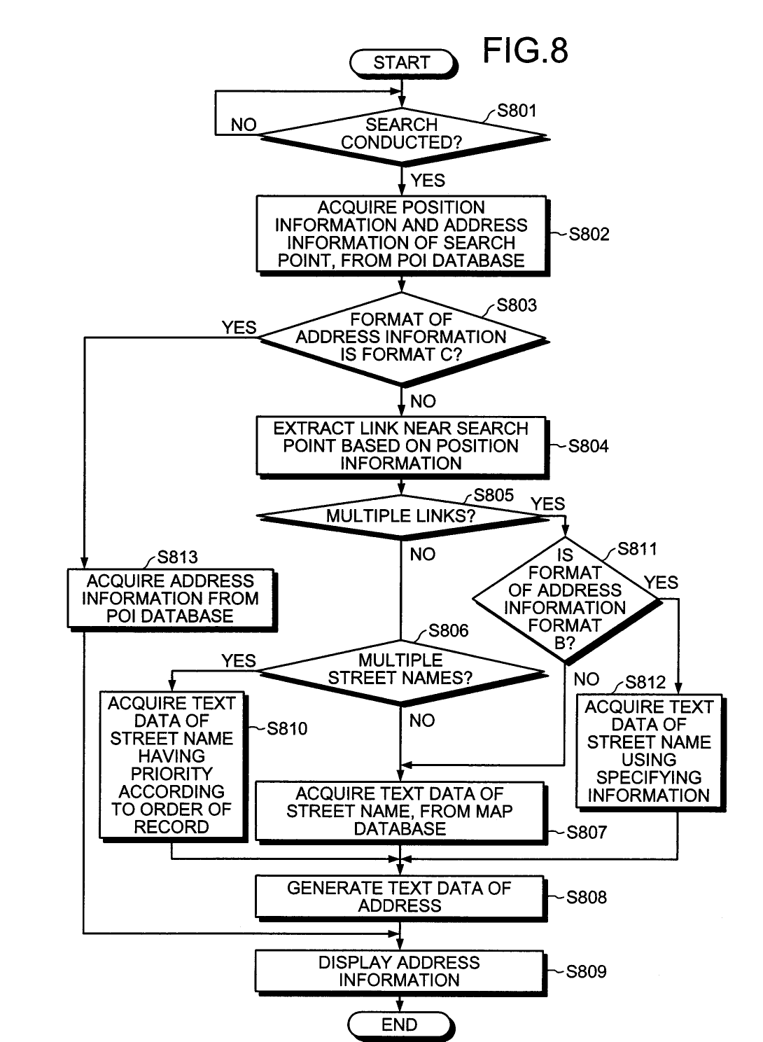

With reference to FIG. 8, an information processing process performed by the navigation apparatus 500 according to Example 1 is explained. FIG. 8 is a flowchart illustrating the information processing process performed by the navigation apparatus 500 according to Example 1.

In FIG. 8, the CPU 501 of the navigation apparatus 500 determines whether a search process for a point is initiated by, for example, the input from a user. Until the search process is executed, the entire process remains in standby (step S801: NO-loop). Once the search process is performed (step S801: YES), the magnetic disk drive 504 is controlled so that position information and address information of a search point are acquired from the POI database of the magnetic disk 505 (step S802).

It is determined whether the record format of the address information is the format C (step S803). If the record format of the address information is not the format C (step S803: NO), namely, if it is determined that a predetermined street name is omitted from the address information, links near the search point (for example in a range of 15 m from the search point) are extracted based on the position information of the search point (step S804). It is determined whether there are multiple links based on the extracted links (step S805).

If it is determined that the number of links is not plural (step S805: NO), in other words, if the record format of the address information is the format A, it is determined whether there are multiple street names (step S806). If there are no multiple street names (step S806: NO), in other words, if it is determined that a point corresponds to the point 1 indicated by reference numeral 703 in FIG. 7, the magnetic disk drive 504 is controlled so that text data of the street name is acquired from the map database of the magnetic disk 505 (step S807).

The text data of the street name acquired from the map database is combined with the address information acquired from the POI database at step S802 so that text data of an address is generated (step S808). The address information of the search point is displayed by the display 512 (step S809), ending the entire process.

At step S806, if there are multiple street names (step S806: YES), in other words, if a point corresponds to the point 2 indicated by reference numeral 703 of FIG. 7, text data of a street name having priority according to the recorded order is acquired from the map database (step S810) so that address data is generated at step S808.

If it is determined that there are multiple links at step S805 (step S805: YES), it is determined whether the record format of the address information is the format B (step S811). If the record format is the format B (step S811: YES), in other words, if a point corresponds to the point 3 and the point 4 indicated by reference numeral 703 of FIG. 7, the magnetic disk drive 504 is controlled so that text data of a street name is acquired from the map database of the magnetic disk 505 using the specifying information (step S812) and address data is generated using the acquired text data at step S808.

If it is determined that the record format of the address information is not the format B at step S811 (step S811: NO), in other words, if the record format of the address information is the format A, the process proceeds to step S807.

According to the record format of the format A in this case, official name, alternate name can be specified only by designating the recorded order under a condition that: there are multiple links near the search point; and the recorded orders of official name or alternate name of the links completely match. This format is used, for example, if multiple links near the search point have an identical official name but different alternate names, the address corresponding to the official name.

If it is determined that the record format of the address information is the format C at step S803 (step S803: YES), the magnetic disk drive 504 is controlled so that the address information is acquired from the POI database of the magnetic disk 505 (step S813), displaying the address information at step S809.

As explained above, according to the navigation apparatus 500 of Example 1, the POI database stores the text data of an address, excluding a predetermined area name and using the text data of the area name stored in the map database, the text data of the address is generated; whereby the volume of data in the POI database is reduced. As a result, the storage area of the navigation apparatus 500 is efficiently used and the performance of the navigation apparatus 500 is prevented from degrading.

Further, if the area name above is a street name, the POI database stores text data of an address excluding a predetermined street name, and the text data of the street name is used from the map database; whereby for points having the same address exclusive of the house number, such as those that face the same street and include a street name in the address, the volume of data amounting to the street name can be reduced in the POI database.

Further, for a point that has multiple streets nearby, the POI database stores the specifying information, namely stores address information in the record format B, and the text data of a name of a street specified by the specifying information is used; whereby the volume of data amounting to the difference between the text data and the specifying information can be reduced in the POI database.

Further, for a point whose nearby street has multiple names, a header part of address information records a recorded number (priority information), and text data of a name of a street designated by a record format number is applied from the map database; whereby the volume of data is reduced in the POI database and a proper address can be displayed even for a point having multiple street names.

Further, for a point whose address includes a predetermined area name that cannot be acquired from the map database, text data of the address including the area name is stored in the POI database as the address information of the point; whereby for points that do not include a predetermined area name in the address or for points that do not have street nearby, the address can be displayed properly in the conventional record format (the format C).

In the present example, the area name that is not stored to the POI database is a street name, but instead of the street name, a city name may be omitted. Namely, the city name may be excluded from POI database. In this way, the POI database stores text data of an address without a predetermined city name, text data of the city name is used from the map database so that the volume of data amounting to the city name in the POI database can be reduced for points having the same city name.

### Example 2

Example 2 of the present invention is explained below. In Example 2, one example of implementing the information creating apparatus by an information creating server is explained. In Example 2, an information creating server that creates the POI database used in Example 1 is explained. Components already explained in Example 1 will be omitted in the explanation below.

### (Hardware Configuration of Information Creating Server)

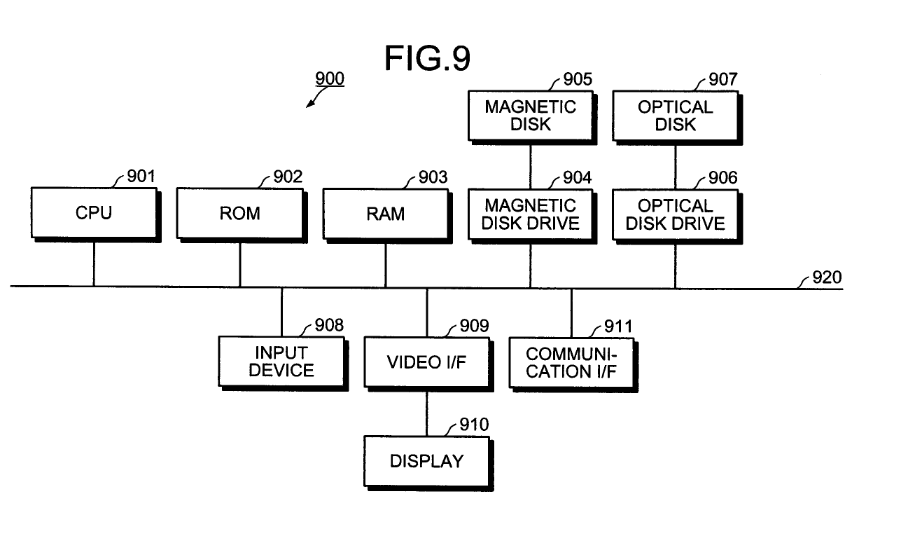

With reference to FIG. 9, a hardware configuration of an information creating server according to Example 2 is explained. FIG. 9 is a block diagram illustrating one example of the hardware configuration of the information creating server according to Example 2.

In FIG. 9, an information creating server 900 includes a CPU 901, a ROM 902, a RAM 903, a magnetic disk drive 904, a magnetic disk 905, an optical disk drive 906, an optical disk 907, an input device 908, an audio I/F (interface) 909, a display 910, and a communication I/F 911, respectively connected by a bus 920.

The CPU 901 governs overall control of the information creating server 900. The ROM 902 stores therein various programs such as a boot program and an information creating program. The RAM 903 is used as a work area of the CPU 901.

Based on map data acquired from the map database of the magnetic disk 905 and the position information and address information of a point such as facilities input from, for example, the input device, the information creating program deletes a street name and stores to the POI database of the magnetic disk 905, address information without the street name if the address information includes a predetermined street (link) name. Specifically, based on map data acquired from the map database and the position information and address information, a street near a point is extracted and if a name of the extracted street is included in the address information, the address information alone, excluding the street name, is stored to the POI database.

If multiple streets are extracted as a nearby street, based on input address information, the information creating program creates specifying information for specifying a street name and stores to the POI database, the specifying information omitting the street name from the address information.

If the extracted nearby street has multiple name, based on the input address information, the information creating program provides priority information (recorded order) indicating priority of street names of the address and stores to the POI database the address information omitting a street name. For address information of a point whose address information does not include a predetermined street name, the information creating program stores to the POI database, the input address information.

The storage controlling unit 350, the extracting unit 360, the creating unit 370, and the assigning unit 380 are implemented by the CPU 901. Namely, functions of the storage controlling unit 350, the extracting unit 360, the creating unit 370, and the assigning unit 380 are implemented by the CPU 901 executing the information creating program.

The magnetic disk drive 904 controls the reading/writing of data to/from the magnetic disk 905 under the control of the CPU 901. The magnetic disk 905 stores data written under the control of the magnetic disk drive 904. The magnetic disk 905 is, for example, a HD (hard disk) or a FD (flexible disk). The magnetic disk drive 904 acquires map data including text data from the map database recorded in the magnetic disk 905. An acquiring unit 340 of FIG. 3 according to the second embodiment is implemented by the magnetic disk drive 904.

The magnetic disk 905 includes a POI database that stores point data having position information and address information of each point, and map database that stores street map data having text data of street names for map display. The address information of the point data is text data of addresses except predetermined street names. For points whose addresses do not include a street name, the magnetic disk 905 stores all text data including an area name in a conventional manner. The point DB 310 and the map DB 320 of FIG. 3 in the second embodiment are implemented by the magnetic disk 905.

The optical disk drive 906 controls the reading/writing of data to/from the optical disk 907 under the control of the CPU 901. The optical disk 907 is a removable recording medium from which data is read out under the control of the optical disk drive 906. The optical disk 907 may be a writable recording medium. The removable recording medium may be a MO, a memory card and so on instead of the optical disk 907.

The input device 908 may be a remote controller, a keyboard, a mouse, a touch panel and so on that includes keys for entering characters, numeric values and various instructions. The position information and the address information of a point such as facilities are input into the input device 908 by an operation of an operator. The input unit 330 of the second embodiment is implemented by the input device 908. The input of the position information and the address information of each point is not limited to the input operation of the operator but may be the reading of data from the POI database. Namely, the input unit 330 of FIG. 3 in the second embodiment may be implemented by the magnetic disk drive 904.

The audio I/F 909 is connected to the display 910. The audio I/F 909 is, for example, made up of a graphic controller that controls the entire display 910, a buffer memory such as VRAM (Video RAM) that temporarily stores immediately displayable image information, and a control IC that controls the display 910.

The communication I/F 911 is wirelessly connected to a network, and also works as an interface between the network and the CPU 901. In this Example, the position information and the address information of each point are acquired through the input device 908 but the position information and the address information of each may be acquired from an external server via the communication I/F 911. The input unit 330 of FIG. 3 in the second embodiment may be implemented by the communication I/F 911.

The point DB 310, the map DB 320, the input unit 330, the acquiring unit 340, the storage controlling unit 350, the extracting unit 360, the creating unit 370, and the assigning unit 380 of the information creating apparatus 300 of FIG. 3 are implemented by the CPU 901 executing programs and data stored in the ROM 902, the RAM 903, the magnetic disk 905, the optical disk 907 of the information creating server 900 in FIG. 9 and controlling each component of the information creating server 900.

The information creating server 900 of the present example can execute the functions of the information creating apparatus 300 of FIG. 3 in the information creating procedure of FIG. 4 by the CPU 901 executing the information creating program stored in, for example, the ROM 902 as a recording medium.

### (Example of Information Creating Process Conducted by Information Creating Server)

With reference to FIG. 10-1 and FIG. 10-2, one example of an information creating process conducted by the information creating server 900 according to Example 2 is explained. FIG. 10-1 and FIG. 10-2 are flowcharts illustrating one example of an information creating process conducted by the information creating server 900 according to Example 2.

In the flowcharts of FIG. 10-1 and FIG. 10-2, the CPU 901 of the information creating server 900 determines whether an instruction of starting the information creating process has been received from, for example, the input device 908 via user operation (step S1001). The entire process remains in standby until an instruction to start the information creating process is received (step S1001: NO-loop). When the start instruction for the information creating process is received (step S1001: YES), the magnetic disk drive 904 acquires map data including text data of street names from the map database of the magnetic disk 905 (step S1002).

The position information and the address information of a point are input via the input device 908 (step S1003). It is determined whether a street name is included in the input address information (step S1004). If the street name is not included in the address information (step S1004: NO), the address information is stored in the POI database (step S1008) in the format C, ending the entire process.

If it is determined that the street name is included in the address information at step S1004 (step S1004: YES), based on the position information (latitude and longitude information) of the input point, it is determined whether there is a link near the point (step S1005). If it is determined that there is no link near the point (step S1005: NO), the process proceeds to step S1008 and the input address information is stored to the POI database in the format C.

If it is determined that there is a link near the point at step S1005 (step S1005: YES), it is determined whether a link has a street name (step S1006). If it is determined that a link does not have a street name (step S1006: NO), the process proceeds to step S1008 and the input address information is stored to the POI database in the format C.

If it is determined that the link has a street name at step S1006 (step S1006: YES), it is determined whether the street name matches the input address information (step S1007). If it is determined that the street name does not match the address information (step S1007: NO), the process proceeds to step S1008, and the input address information is stored to the POI database in the format C.

If the street name matches the address information (step S1007: YES), it is determined whether there are multiple links (step S1009). If the number of links is not plural (step S1009: NO), namely if there is only one link, it is determined whether there are multiple street names (step S1010).

If the number of street names is not plural (step S1010: NO), namely if there is only one street name, the street name is deleted from the address information input form the input device 908 (step S1011). The address information without the street name is stored to the POI database (step S1012) in the format A, ending the entire process.

If it is determined that the there are multiple street names at step S1010 (step S1010: YES), the street name included in the address information is compared with multiple street names stored in the street map data (step S1013) and the recorded order of the matched street name is acquired (step S1014). For example, if the street name in the address information corresponds to an official name of the street name in the street map data as a result of the comparison at step S1013, the recorded order “00” that indicates the official name (see FIG. 7) is acquired at step S1014.

The recorded order is designated (assigned) (step S1015) and the street name is deleted from the address information at step S1011. If it is determined that there are multiple links at step S1009 (step S1009: YES), it is determined whether there are multiple street names (step S1016). If it is determined that there is not multiple street name (step S1016: NO), namely if there is only one street name, the specifying information is created by comparing text data of a street name included in the address information with text data of a street name included in the street map data, and the street name is deleted from the address information (step S1017).

The address information without the street name and the specifying information are stored in the POI database (step S1018) in the format B, ending the entire process. If it is determined that there are multiple street names at step S1016 (step S1016: YES), it is determined whether a street name included in the address information is present in each link of the street map data as an official name or an alternate name, and is stored in the same order in each link (step S1019).

If it is determined that a street name included in the address information is present in each link of the street map data as official name, or alternate name and is recorded in the same order in the links (step S1019: YES), the process goes to step S1011 and the subsequent steps, storing the address information as the format A. If a street name included in the address information is present in each link of the street map data as official name, or alternate name but is not recorded in the same order in the links (step S1019: NO), the process proceeds to step S1017.

### (Relation Between Link in Format A and Point)

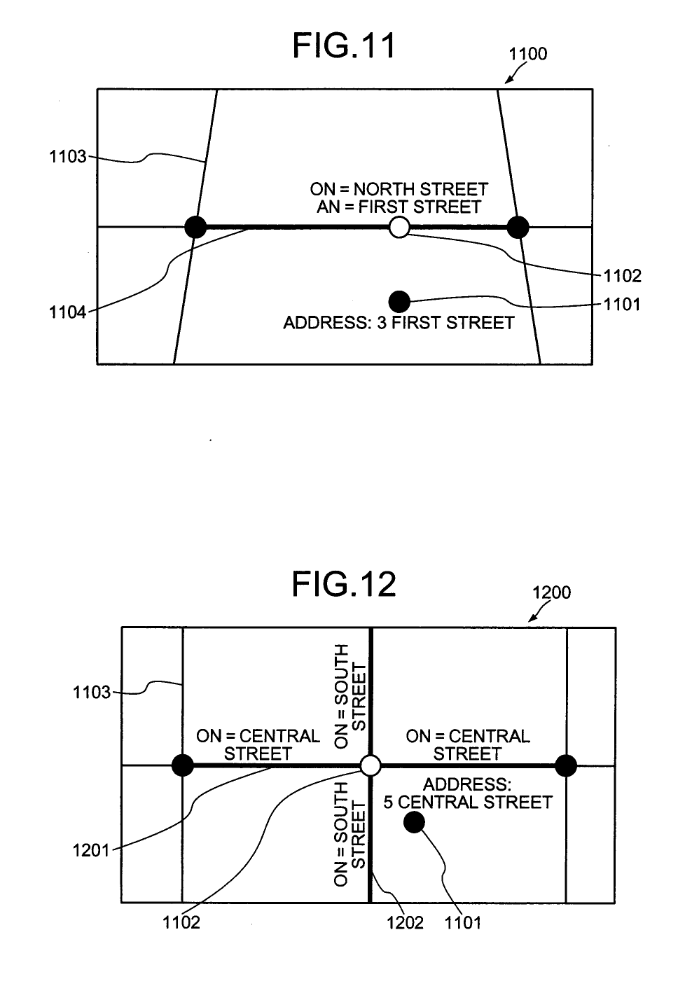

With reference to FIG. 11, a relation between a link of the format A and a point is explained. FIG. 11 is a diagram illustrating a relation between a link of the format A and a point. In FIG. 11, a relation between a link corresponding to the point 2 indicated by reference numeral 703 of FIG. 7 and a point is explained.

In a diagram 1100 of FIG. 11, a POI facility position 1101, a guide point 1102, a street link 1103, and a nearby link 1104 are present. The guide point 1102 denotes an entrance point of POI facilities and is a point connecting the POI facilities position 1101 and the nearby link 1104. The nearby link 1104 is part of the street link within a range of, for example, 15 m from the guide point 1102.

As for the nearby link 1104, “ON (official name)” is “north street” and “AN (alternate name)” is “first street”. An address of the POI facilities position 1101 includes the alternate name of “first street”. The “ON” and “AN” are stored to the map database. With the assumption that the official name of “north street” is recorded first and the alternate name of “first street” is recorded second, a record order “01” indicating the second position of “first street” is set in the POI database.

If the address of the POI facilities position 1101 includes “north street” as an official name and the “north street” is recorded first in the map database, the record order of “00” is set in the POI database.

Even if there are multiple alternate names or official names, advantages are not lost because street names are associated with record orders in the map database and the record orders are set in the POI database. In this example, a record number is one less than the record order in the street database but the embodiment is not limited to this example. Without a record number “00”, the order may start with “01”.

### (Relation Between Link of Format B and a Point)

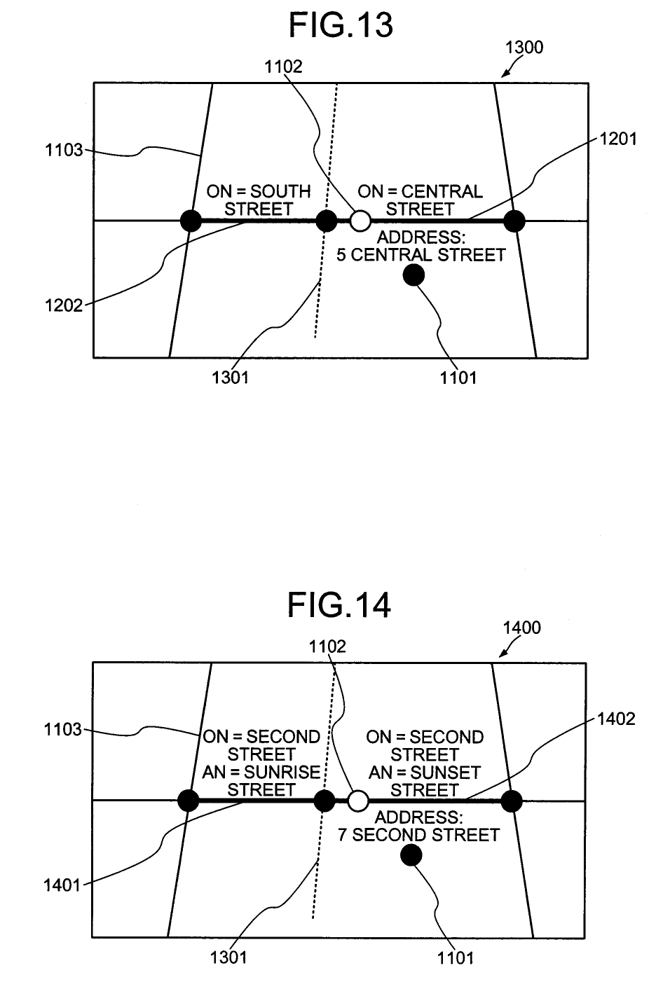

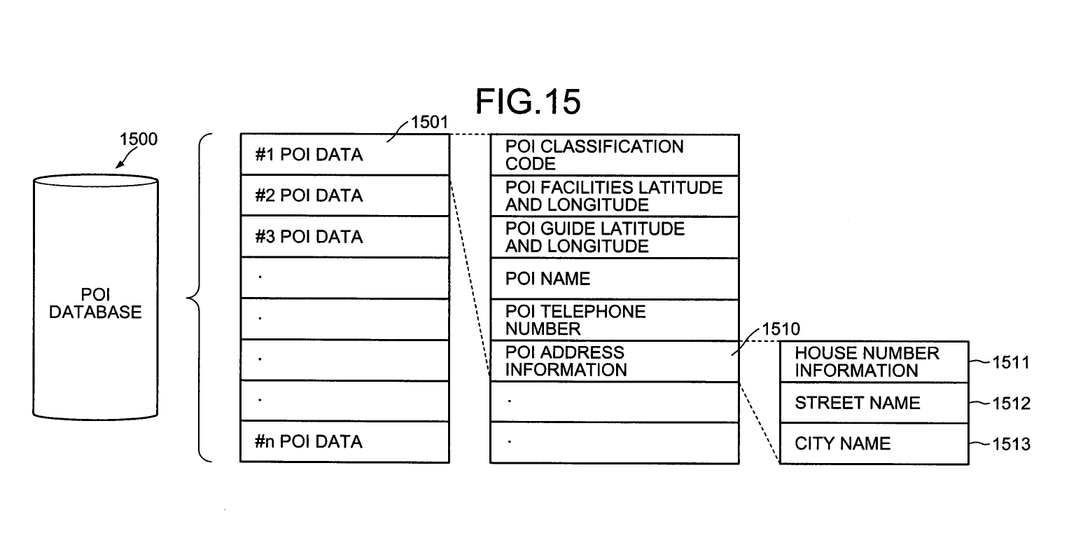

With reference to FIG. 12 and FIG. 13, a relation between a link of the format B and a point is explained. FIG. 12 and FIG. 13 are diagrams illustrating the relation between a link of the format B and a point. In FIG. 12 and FIG. 13, a relation between the point 2 indicated by reference numeral 703 of FIG. 7 and a point is explained. In the explanation below, elements explained in FIG. 11 are given the same reference numerals used in FIG. 11 and explanations thereof are omitted.

In a diagram 1200 of FIG. 12, the POI facilities position 1101 is present near a cross road. The guide point 1102 is located at the cross road. Nearby links 1201, 1202 are formed with two crossing street links 1103. The nearby link 1201 is called “central street”. The nearby link 1202 is called “south street”. The address of the POI facilities position 1101 includes “central street”. In this case, the POI database stores “c” as the specifying information that indicates “central street” and is used for acquiring the text data of “central street” from the map database.

In a diagram 1300 of FIG. 13, nearby links 1201, 1202 have different “ON” across a boundary of cities. The nearby link 1201 is called “central street”. The nearby link 1202 is called “south street”. The address of the POI facilities position 1101 includes “central street”. In this case, the POI database stores “c” as the specifying information that specifies the “central street” and is used for acquiring the text data of “central street” from the map database.

### (Relation Between Point and Link Expressed With Format A Even When There are Multiple Links)

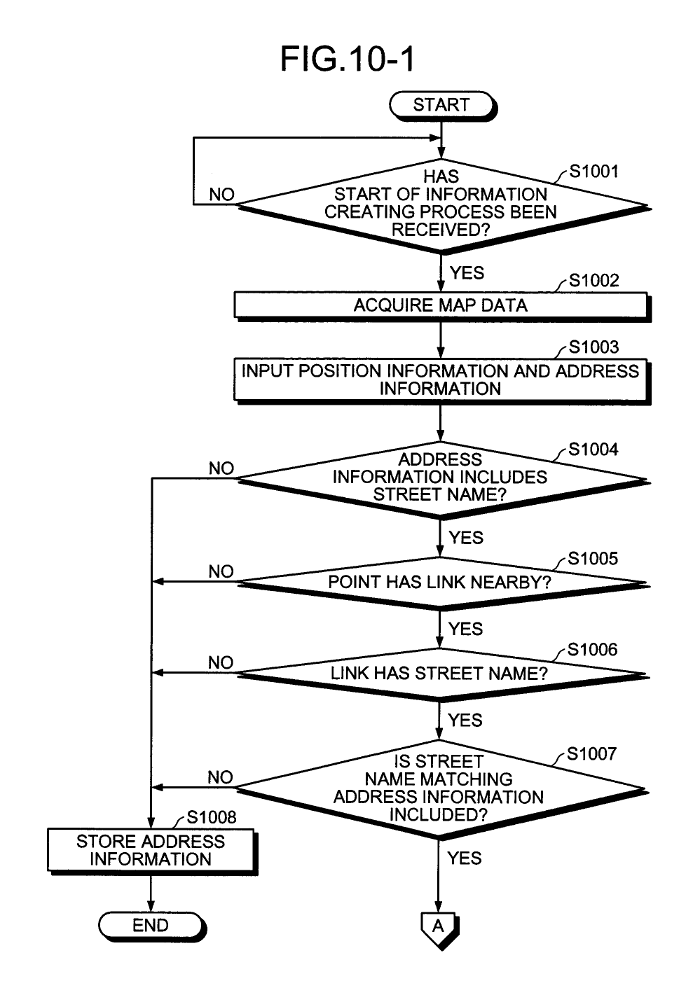

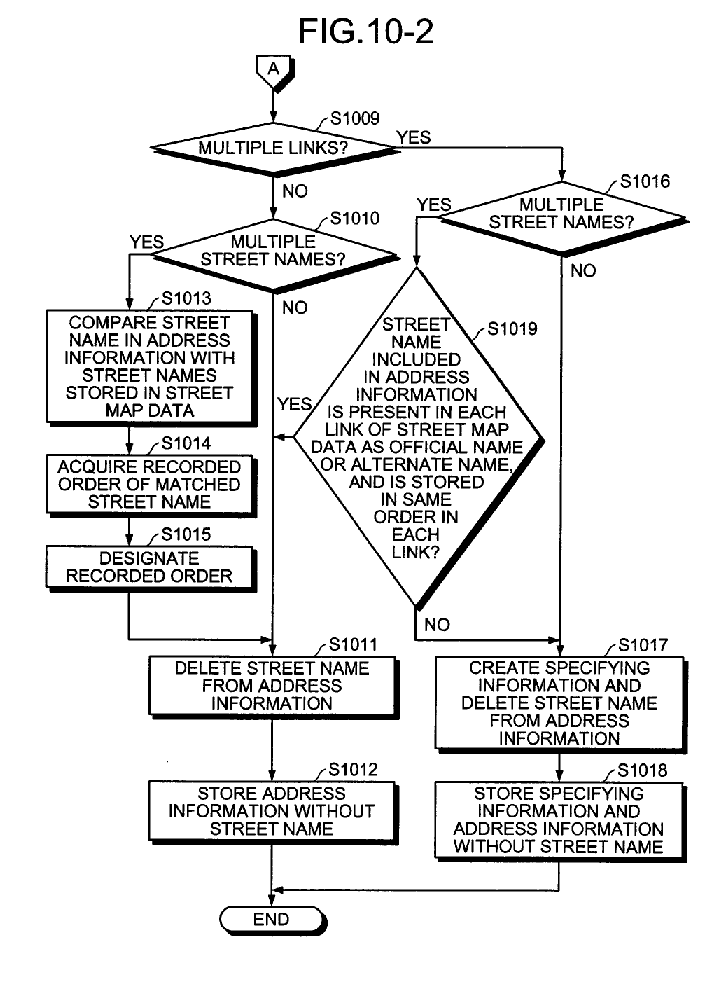

With reference to FIG. 14, a relation between a point and a link expressed with the format A even if there are multiple links is explained. FIG. 14 is a diagram illustrating a relation between a point and a link expressed with the format A even if there are multiple links. FIG. 14 illustrates the relation between a link and a point corresponding to step S1019, YES of FIG. 10-2.

In a diagram 1400 of FIG. 14, there are multiple nearby links 1401, 1402 whose “ON”s are identical (“second street”), but whose “AN”s are different. The nearby links 1401, 1402 have different “AN”s across a boundary of cities. The “AN” of the nearby link 1401 is “sunrise street” while the “AN” of the nearby link 1402 is “sunset street”. The record order of each link for the official name “ON” is “00” and for the alternate name “AN” is “01”. In this case, since the address information matches the “ON” of each link and the record orders “00” of each link coincide, the format “A” can be applied.

In FIG. 11 to FIG. 14, some facilities may not have the POI facilities position 1101 but in such a case, the guide point 1102 replaces the POI facilities position 1101 to determine the format.

In this example, an area name that is not stored in the POI database is the street name but can be the city name. The city name is excluded from the POI database and is applied from the map database. An approach to a case where a city has both official name and alternate name is to give a record order or store the specifying information near a boundary of cities as the case of the street name.

In this example, an area name that is not stored in the POI database an area name that is not stored in the POI database can be a house number. The house number is excluded from the POI database and is applied from the map database. In this case, an area where a house number is assigned for a link divided by a predetermined ratio is considered.

For example, if the information creating server 900 divides a link to a given number of sub-links and the dividing ratio corresponds to house numbers of the actual address, the house numbers are excluded from the POI database. To be more specific, it is assumed that the house numbers 1 to 50 are assigned to a link from one end to the other end. The link is divided to 50 sub-links that correspond to the house numbers. In this case the house numbers are excluded from the POI database. In this way, the volume of data amounting to the house numbers is reduced in the POI database.

Further, the navigation apparatus 500 uses the position information of a point and judges which part of the link a point corresponds to so that the navigation apparatus acquires from the map database and outputs an appropriate house number. When the actual house numbers do not match the dividing ratio of a link, for example, when the house numbers from one end of the link to the other end are not in order, the house numbers are stored to the POI database in a conventional manner.

As explained above, according to the information creating server 900 of Example 2, if the address information of the points includes a predetermined area name stored in the map database, the POI database stores the address information without the area name; whereby the volume of data in the POI database can be reduced.

If the address information of each point includes the street name stored in the map database while an area name is a street name, the POI database store the address information except the street name; whereby the volume of data amounting to street names can be reduced in the POI database.

If multiple streets are present near a point, the specifying information for specifying a street name is created and the specifying information is stored in the POI database excluding the street name from the address information. In other words, the address information is stored in the format B. As a result, the volume of data amounting to the difference between text data and the specifying information can be reduced in the POI database.

If a street near a point has multiple street names, a record order indicating the priority of a street name is given (designated) and the address information without the street name is stored in the POI database after the priority information is given; whereby the volume of data in the POI database can be reduced and the address of a point having multiple street names can be properly displayed.

If an address of a point includes a city name stored in the map database while the area name is the city name, the address information except the city name is stored in the POI database; whereby the volume of data amounting to city names can be reduced in the POI database.

For a point whose address information does not include a predetermined area name, the POI database stores the address information including the area name; whereby for a point whose address does not include an are name or a point having no street nearby, an address can be properly displayed in a conventional manner (format C).

As set forth above, according to the information processing apparatus, the information creating apparatus, the information processing method, the information creating method, the information processing program, the information creating program, and the recording medium of the present invention, the volume of data in the POI database can be reduced.

The information processing method and the data creating method explained in Examples 1 and 2 can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

1-17. (canceled)

18. An information processing apparatus comprising:
a point database that includes position information and address information of a point and with which a point search process is executed, the address information being text data of an address without a predetermined area name;
a map database that includes text data of an area name for displaying a map and with which a map display process is executed; and
a control unit that, when a process is executed that uses text data of an address of a search point retrieved by the point search process, acquires from the point database, the position information and the address information of the search point, acquires based on the position information of the search point and from the map database, the text data of the area name in the address of the search point, combines the address information of the search point and the text data of the area name, and generates the text data of the address of the search point.

19. The information processing apparatus according to claim 18, wherein
the area name is a street name, and
the control unit acquires from the map database, text data of a street name of a street near the search point as text data of a street name in the address of the search point, combines the address information of the search point and the text data of the street name, and generates the text data of the address of the search point.

20. The information processing apparatus according to claim 19, wherein
the point database has, for a point having multiple streets nearby, specifying information for specifying a street having a street name included in an address of the point, and
the control unit acquires from the map database, text data of a street name of a street specified by the specifying information of the search point, as the text data of the street name in the address of the search point if the search point has multiple streets nearby.

21. The information processing apparatus according to claim 19, wherein
the point database has, for a point whose nearby street has multiple street names, priority information indicating priority of the multiple street names,
the control unit, if the street near the search point has multiple street names, acquires text data of a street name having priority based on the priority information, as the text data of the street name in the address of the search point.

22. The information processing apparatus according to claim 18, wherein
the area name is a city name,
the control unit acquires from the map database, text data of a city name of a city to which the search point belongs, as text data of the city name in the address of the search point, combines the address information of the search point and the text data of the city name, and generates text data of the address of the search point.

23. The information processing apparatus according to claim 18, wherein for a point whose address includes a predetermined area name that cannot be acquired from the map database, the point database stores text data of an address that includes the predetermined area name, as the address information of the point.

24. An information creating apparatus comprising:
a map database that stores map data including text data of an area name for displaying a map;
an acquiring unit that acquires from the map database map, map data including text data of an area name;
an input unit that receives position information and address information of a point;
a storage controlling unit that, based on the acquired map data, the received position information and the received address information and with respect to address information that includes a predetermined area name, stores the address information alone to a point database, excluding the predetermined area name.

25. The information creating apparatus according to claim 24, further comprising an extracting unit that extracts streets near the point, based on the acquired map data, the received position information, and the received address information, wherein
the area name is a street name, and
the storage controlling unit, if a street name of the street extracted by the extracting unit is included in the address information, stores the address information alone to the point database, excluding the street name.

26. The information creating apparatus according to claim 25, further comprising a creating unit that based on the address information received by the input unit, creates specifying information for specifying a street name included in an address of the point, if multiple streets near the point are extracted by the extracting unit.

27. The information creating apparatus according to claim 24, further comprising an assigning unit that based on the address information received by the input unit, assigns priority information indicating priority of a street name included in an address of the point, wherein
the storage controlling unit, if the priority information has been assigned by the assigning unit, stores the address information alone to the point database, excluding the street name.

28. The information creating apparatus according to claim 24, further comprising an extracting unit that extracts a city name of the point, based on the acquired map data, the received position information, and the received address information, wherein
the area information is a city name,
the storage controlling unit, if the extracted city name is included in the address information, stores the address information alone to the point database, excluding the city name.

29. The information creating apparatus according to claim 24, wherein the storage controlling unit, for a point whose address information does not include a predetermined area name, stores to the point database, the address information received by the input unit.

30. An information processing method for an information processing apparatus that includes a point database having position information and address information of a point and a map database having text data of an area name for displaying a map, executes a point search process using the point database, and executes a map displaying process using the map database, the method comprising:
a first acquiring step of acquiring from the point database, when a process is executed that uses text data of an address of a search point retrieved by the point search process, position information and address information of the point;
a second acquiring step of acquiring from the map database, text data of an area name in the address of the search point, based on the acquired position information of the search point; and
a generating step of generating text data of the address of the search point by combining the address information of the search point and the text data of the area name.

31. An information creating method for an information creating apparatus that includes a map database storing map data having text data of an area name for displaying a map and a point database storing position information and address information of a point, the method comprising:
an acquiring step of acquiring from the map database, map data including text data of an area name;
an input step of receiving position information and address information of a point;
a storage control step of storing address information to the point database, wherein for address information that includes a predetermined area name, the address information alone is stored excluding the predetermined area name, based on the acquired map data, the received position information and the received address information.

32. A non-transitory, computer-readable recording medium storing therein an information processing program causing a computer to execute the information processing method according to claim 30.
